(19) United States
(12) Patent Application Publication
(10) Pub. No.: US 2026/0084751 A1
(43) Pub. Date: Mar. 26, 2026

(54) VEHICLE FRONT STRUCTURE

(71) Applicant: HONDA MOTOR CO., LTD., Tokyo (JP)

(72) Inventors: Katsuya Fujimori, Tokyo (JP); Ryohei Hayashi, Tokyo (JP); Xiaoqi Yang, Tokyo (JP)

(21) Appl. No.: 19/335,288

(22) Filed: Sep. 22, 2025

(30) Foreign Application Priority Data
Sep. 24, 2024 (JP) 2024-165234

(51) Int. Cl. B62D 25/08; B62D 21/15; B62D 29/00

(52) U.S. Cl. CPC B62D 21/152; B62D 29/007; B62D 29/008

(57) ABSTRACT

This vehicle front structure including a suspension support structure, the suspension support structure includes: a damper housing, which is a casting part with an open cross section opening outward in a vehicle width direction, having an upper wall with a damper connecting portion and a cover wall extending downward from a circumferential edge of the upper wall; and a reinforcement member configured to cover at least a part of an outer opening portion of the open cross section of the damper housing in the vehicle width direction.

### CROSS-REFERENCE TO RELATED APPLICATION

The present application claims priority based on Japanese Patent Application No. 2024-165234, filed Sep. 24, 2024, the content of which is incorporated herein by reference.

### BACKGROUND OF THE INVENTION

### Field of the Invention

The present invention relates to a vehicle front structure.

### Description of Related Art

As a vehicle front structure, it is known that a pair of damper housings, spaced apart on the left and right sides of a vehicle, are integrally formed by casting an aluminum alloy (for example, see Chinese Utility Model No. 217649533).

In the vehicle front structure disclosed in Chinese Utility Model No. 217649533, a rearward extending portion extending toward the rear side of the vehicle is connected to each of the left and right damper housings, and the rear portions of the left and right rearward extending portions are connected to a floor connecting block extending in a vehicle width direction. The left and right damper housings, the left and right rearward extending portions, and the floor connecting block are integrally formed by casting an aluminum alloy.

The left and right damper housings constitute a suspension support structure, and a damper, a spring, a wheel support member, and the like, which are suspension members, are disposed inside an upper wall and a cover wall connected to the upper wall. A damper connecting portion to which an upper end portion of the damper is connected is provided on the upper wall of the damper housing. In addition, since the damper housing is demolded from the outer side in the vehicle width direction during casting, the main part (the cover wall connected to the upper wall) is an open cross section that is open toward the outward side in the vehicle width direction.

The damper housing receives a large vertical load from a suspension when the vehicle is moving, and also functions as a member that distributes and transmits the input load over a wide range to the rear of the vehicle body when an impact load is input from the front of the vehicle. For this reason, in the open cross-sectional portion of the damper housing, the wall portion is reinforced with a plurality of reinforcement ribs to increase the strength and rigidity of the open cross-section. The plurality of reinforcement ribs are formed integrally with the damper housing during casting.

### SUMMARY OF THE INVENTION

However, in the vehicle front structure disclosed in Chinese Utility Model No. 217649533, although the open cross-sectional portion of the damper housing is reinforced by the plurality of reinforcement ribs, the reinforcement ribs themselves must be designed so that the entire wall portion is open to the outer side in the vehicle width direction, taking into account their demolding ability during casting. For this reason, in order to adequately withstand the vertical load input to the suspension and the impact load from the front of the vehicle, it is necessary to increase the wall portion of the damper housing and the wall thickness of the reinforcement ribs.

An aspect of the present invention is directed to providing a vehicle front structure capable of suppressing an increase in wall thickness of a member, and achieving improvement of strength and rigidity of a damper housing with respect to an input load. Then, the present invention ultimately aims to achieve improved collision safety performance.

In order to accomplish the above-mentioned purposes, a vehicle front structure according to an aspect of the present invention employs the following configurations.

(1) An aspect of the present invention is a vehicle front structure including a suspension support structure (for example, a suspension support structure (15) of an embodiment), the suspension support structure including: a damper housing (for example, a damper housing (10) of the embodiment), which is a casting part with an open cross section opening outward in a vehicle width direction, having an upper wall (for example, an upper wall (10a) of the embodiment) with a damper connecting portion (for example, a damper connecting portion (16) of the embodiment) and a cover wall (for example, an cover wall (10b) of the embodiment) extending downward from a circumferential edge of the upper wall; and a reinforcement member (for example, a reinforcement member (30) of the embodiment) configured to cover at least a part of an outer opening portion (for example, an opening portion (52) of the embodiment) of the open cross section of the damper housing in the vehicle width direction.

According to the aspect of the above-mentioned (1), when a vertical load input to the suspension or an external impact load is input to the damper housing, the load is received by the damper housing and the reinforcement member which covers at least a part of the opening portion of the damper housing. Here, since at least a portion of the opening portion of the damper housing is covered by the reinforcement member, deformation of the opening portion of the damper housing is suppressed by the reinforcement member. Accordingly, in the vehicle front structure of the configuration, it is possible to increase the strength and rigidity of the damper housing while suppressing an increase in the wall thickness of the damper housing.

(2) In the aspect of the above-mentioned (1), the reinforcement member may include an inclined wall (for example, an inclined wall (30d) of the embodiment) that slopes outward in the vehicle width direction from the front of the vehicle toward the rear of the vehicle beyond the damper connecting portion.

According to the aspect of the above-mentioned (2), when an impact load is input to the front portion of the damper housing from the front of the vehicle, the deformation of the opening portion of the damper housing is suppressed by the reinforcement member, and the impact load input to the front portion of the reinforcement member is transmitted smoothly to the outside and the rear of the vehicle in the vehicle width direction through the inclined wall of the reinforcement member. Accordingly, when the configuration is employed, the impact load input to the front portion of the damper housing can be efficiently transmitted to the frame member or the like outside and behind the vehicle in the vehicle width direction.

(3) In the aspect of the above-mentioned (2), the reinforcement member may have an upper wall portion (for example, an upper wall portion (30a) of the embodiment) extending along the upper wall of the damper housing and joined to the upper wall; and the inclined wall extending to be bent or curved downward from an end portion of the upper wall portion.

According to the aspect of the above-mentioned (3), since the upper wall portion and the inclined wall of the reinforcement member are connected in a bent or curved manner, a highly rigid ridge portion is formed between the upper wall portion and the inclined wall in the extension direction of the inclined wall. Accordingly, when the configuration is employed, the highly rigid ridge portion formed between the upper wall portion and the inclined wall enables the impact load input to the front portion of the damper housing to be transmitted more smoothly to the outside and the rear of the vehicle in the vehicle width direction.

(4) In the aspect of the above-mentioned (2), the inclined wall may be disposed to overlap a connecting portion (for example, a connecting portion (31) of the embodiment) of a load-receiving member (for example, a load-receiving member (20) of the embodiment) connected to a front portion of the damper housing and a bumper beam (for example, a bumper beam (14) of the embodiment) of a vehicle front portion in a vehicle forward/rearward direction when seen in a plan view.

According to the aspect of the above-mentioned (4), when an impact load is input from the front to a position offset to one side in the leftward or rightward direction of the vehicle, the load is transmitted to one of the load-receiving members through the connecting portion with the bumper beam. Since the inclined wall of the reinforcement member is positioned to overlap the connecting portion between one of the load-receiving members and the bumper beam in the vehicle forward/rearward direction when seen in a plan view, the impact load is transmitted from the front to the inclined wall through one of the load-receiving members. Here, the direction of action of the impact load input to the bumper beam is deflected inward in the vehicle width direction through the inclined wall. As a result, the front portion of the vehicle moves inward to retreat (away) from the input position of the impact load in the vehicle width direction. Accordingly, when the configuration is employed, it is possible to reduce the impact load input to the vehicle front portion.

(5) In the aspect of the above-mentioned (2), the damper housing and the reinforcement member may be provided separately at left and right positions in the vehicle width direction, the left and right damper housings may be connected by a connecting beam (for example, a lower connecting beam (12) and an upper connecting beam (67) of the embodiment) substantially extending in the vehicle width direction, and the left and right reinforcement members may be disposed such that the inclined wall overlaps an extension region of the connecting beam in a vehicle forward/rearward direction and at least a part thereof in the vehicle forward/rearward direction.

According to the aspect of the above-mentioned (5), since the left and right damper housings are connected by the connecting beam that extends substantially in the vehicle width direction, deformation of the left and right damper housings caused by vertical loads input to the suspension and external impact loads can be suppressed by the connecting beam. In addition, since each of the inclined walls of the left and right reinforcement members at least partially overlaps the extension region of the connecting beam in the vehicle forward/rearward direction, when the impact load is input to the inclined wall of the reinforcement member from the front of the vehicle, the impact load can be efficiently deflected in the extension direction of the connecting beam via the inclined wall. Accordingly, when the configuration is employed, it is possible to deflect and transmit the input impact load to the connecting beam.

(6) In the aspect of the above-mentioned (5), the connecting beam may have an upper connecting beam (for example, an upper connecting beam (67) of the embodiment) configured to connect the damper connecting portions of the left and right damper housings; and a lower connecting beam (for example, a lower connecting beam (12) of the embodiment) located below the reinforcement member and configured to connect the left and right damper housings.

According to the aspect of the above-mentioned (6), the upper connecting beam and the lower connecting beam are arranged spaced apart in the upward/downward direction, forming a closed cross section between the left and right damper housings. For this reason, the upper connecting beam and lower connecting beam, together with the left and right damper housings, form a highly rigid closed cross-sectional structure. Accordingly, when the configuration is employed, it is possible to support the load input to the damper housing with high rigidity. In addition, when the impact load is input to the inclined wall of the reinforcement member, the closed cross-sectional structure suppresses deformation of the connecting beams (the upper connecting beam and the lower connecting beam) and ensures load transmission from the connecting beams to a wide range of parts of the vehicle.

(7) In the aspect of the above-mentioned (2), the upper wall of the damper housing may have an upper wall inclined portion (for example, an upper wall inclined portion (70i) of the embodiment) inclined outward from the damper connecting portion in the vehicle width direction from the front toward the rear of the vehicle, and the inclined wall of the reinforcement member may be disposed to protrude outward and forward from the upper wall inclined portion in the vehicle width direction when seen in a plan view.

According to the aspect of the above-mentioned (7), since the inclined wall of the reinforcement member, when seen in a plan view, protrudes outward in the vehicle width direction and forward further than the upper wall inclined portion of the damper housing, when an impact load is input from the front of the vehicle, if an object on a front side moves toward the upper wall inclined portion of the damper housing, the inclined wall of the reinforcement member will come into contact with the object first. Accordingly, when the configuration is employed, the reinforcement member can further suppress deformation of the damper housing when an impact load is input.

(8) In the aspect of the above-mentioned (3), the reinforcement member may further have a front wall portion (for example, a front wall portion (30c) of the embodiment) extending downward from the upper wall portion at a position in front of the vehicle and connected to a front end portion of the inclined wall; and a sidewall portion (for example, a sidewall portion (30b) of the embodiment) extending downward from the upper wall portion at an outer position in the vehicle width direction and connected to a rear end portion of the inclined wall, and the front wall portion and the sidewall portion may be joined to the edge portion of the open cross section of the damper housing, so that the opening portion is closed by the reinforcement member in a horizontal cross section including the inclined wall.

According to the aspect of the above-mentioned (8), the front wall portion and the sidewall portion of the reinforcement member are joined to the edge portion of the opening portion of the damper housing, such that the opening portion of the damper housing is closed in a cross section including the inclined wall of the reinforcement member. Accordingly, the front and rear of the inclined wall of the reinforcement member are joined to the edge portion of the open cross section of the damper housing, allowing the reinforcement member to efficiently regulate the deformation of the open cross section of the damper housing. Accordingly, when the configuration is employed, it is possible to increase the strength and rigidity of the damper housing while suppressing an increase in the wall thickness of the damper housing.

(9) In the aspect of the above-mentioned (1) or (2), the damper housing may be constituted by an aluminum alloy casting part, and the reinforcement member may be formed of a metal material with higher tensile strength than the damper housing.

According to the aspect of the above-mentioned (9), since the reinforcement member, which covers at least a part of the opening portion of the damper housing, is made of a metal material (for example, steel or titanium alloy) that has a higher tensile strength than the damper housing, the deformation of the damper housing can be regulated by the reinforcement member even if the damper housing is subjected to vertical loads or impact loads from the suspension.

(10) In the aspect of the above-mentioned (2), the vehicle front structure may further include a lower side load-receiving portion (for example, a lower side load-receiving portion (21) of the embodiment) with an open cross section formed on at least two surfaces substantially extending in a vehicle forward/rearward direction, a rear portion of which is joined to the suspension support structure by joining a bumper beam (for example, a bumper beam (14) of the embodiment) to a front portion; an upper side load-receiving portion (for example, an upper side load-receiving portion (22) of the embodiment) with an open cross section formed on at least two surfaces substantially extending in the vehicle forward/rearward direction above the lower side load-receiving portion, a rear portion of which is joined to the suspension support structure; and a connecting wall portion (for example, a connecting wall portion (28) of the embodiment) configured to continuously connect the lower side load-receiving portion and the upper side load-receiving portion in a vehicle forward/rearward direction, a load transmission wall (for example, an upper side load transmission wall (26) of the embodiment) extending in a direction crossing the vehicle forward/rearward direction and joined to the suspension support structure may be provided on a rear portion of the upper side load-receiving portion, the reinforcement member may have an upper wall portion extending along the upper wall of the damper housing and joined to the upper wall; the inclined wall extending downward from an end portion of the upper wall portion; a front wall portion (for example, a front wall portion (30c) of the embodiment) extending downward from the upper wall portion at a position in front of the vehicle and connected to a front end portion of the inclined wall; and a sidewall portion (for example, a sidewall portion (30b) of the embodiment) extending downward from the upper wall portion at an outer position in the vehicle width direction and connected to a rear end portion of the inclined wall, and the load transmission wall may be joined to the damper housing and the front wall portion of the reinforcement member.

According to the aspect of the above-mentioned (10), when an impact load is input from the front of the vehicle, the load is input through the bumper beam into the lower side load-receiving portion. A part of the load input to the front portion of the lower side load-receiving portion is transmitted directly to the suspension support structure of the rear portion through the lower side load-receiving portion. In addition, another part of the load input to the front portion of the lower side load-receiving portion is transmitted to the upper side load-receiving portion through the connecting wall portion. Here, since the connecting wall portion continuously connects the lower side load-receiving portion and the upper side load-receiving portion in the forward/rearward direction of the vehicle, the load is transmitted in a distributed manner over a wide range of the upper side load-receiving portion in the forward/rearward direction. The load input to the upper side load-receiving portion is transmitted to the suspension support structure of the rear portion through the load transmission wall.

In addition, when an impact load is input from the front of the vehicle to the front portion of the upper side load-receiving portion, a part of the load is transmitted to the suspension support structure of the rear portion through the upper side load-receiving portion, and the other part of the load is transmitted to the suspension support structure of the rear portion through the connecting wall portion and the lower side load-receiving portion.

In the configuration, since the lower side load-receiving portion and the upper side load-receiving portion, which transmit the impact load from the vehicle front portion to the rear suspension support structure, are open cross-sections (not closed cross-sections), partial rigidity differences are less likely to occur in almost the entire area of the vehicle in the upward/downward direction. For this reason, the load is transmitted approximately evenly over the lower side load-receiving portion, the connecting wall portion, and the upper side load-receiving portion. Accordingly, when an impact load is input from the front of the vehicle, the lower side load-receiving portion, the connecting wall portion, and the upper side load-receiving portion all deform almost evenly, allowing the energy of the impact load to be absorbed efficiently.

Further, in the configuration, the load transmission wall of the rear portion of the upper side load-receiving portion is connected to the damper housing and the front wall portion of the reinforcement member. For this reason, when the configuration is employed, the impact load transmitted to the upper side load-receiving portion can be efficiently transmitted to the damper housing and the front wall portion of the reinforcement member through the load transmission wall.

An aspect of the present invention is directed to including a reinforcement member that covers at least a portion of an opening portion on an outer side in the vehicle width direction of an open cross-section of a damper housing. For this reason, deformation of the opening portion of the damper housing can be suppressed by the reinforcement member. Accordingly, when the vehicle front structure according to the present invention is employed, it is possible to achieve an improvement in the strength and rigidity of the damper housing against the input load while suppressing an increase in the wall thickness of the member.

### BRIEF DESCRIPTION OF THE DRAWINGS

FIG. 1 is a perspective view of a vehicle front portion of an embodiment.

FIG. 2 is a perspective view of the vehicle front portion, some members in FIG. 1 of which are shown by virtual lines.

FIG. 3 is a side view when the vehicle front portion of the embodiment is seen from an outer side of a vehicle width direction.

FIG. 4 is a front view when a load-receiving member of the embodiment is seen from a side in front of a vehicle.

FIG. 5 is a plan view of the vehicle front portion of the embodiment.

FIG. 6 is a front view of a suspension support structure of the embodiment.

FIG. 7 is a perspective view of a part of the suspension support structure of the embodiment.

FIG. 8 is a plan view of the part of the suspension support structure of the embodiment.

FIG. 9 is a cross-sectional view along line IX-IX in FIG. 7.

FIG. 10 is a cross-sectional view along line X-X in FIG. 7.

FIG. 11 is a perspective view of a reinforcement member of the embodiment.

FIG. 12 is a plan view of the vehicle front portion of the embodiment.

FIG. 13 is a perspective view when the suspension support structure of the embodiment is seen from a vehicle compartment side.

FIG. 14 is a perspective view when the suspension support structure of the embodiment to which a dash lower panel is attached is seen from the vehicle compartment side.

### DESCRIPTION OF EMBODIMENTS

Hereinafter, an embodiment of the present invention will be described with reference to the accompanying drawings.

In the following description, directions of forward, rearward, upward, downward, leftward and rightward are the same as those in a vehicle 1 unless the context indicates otherwise. In addition, in the drawings, an arrow FR indicates a forward direction of a vehicle, an arrow UP indicates an upward direction of the vehicle, and an arrow LH indicates a leftward direction of the vehicle.

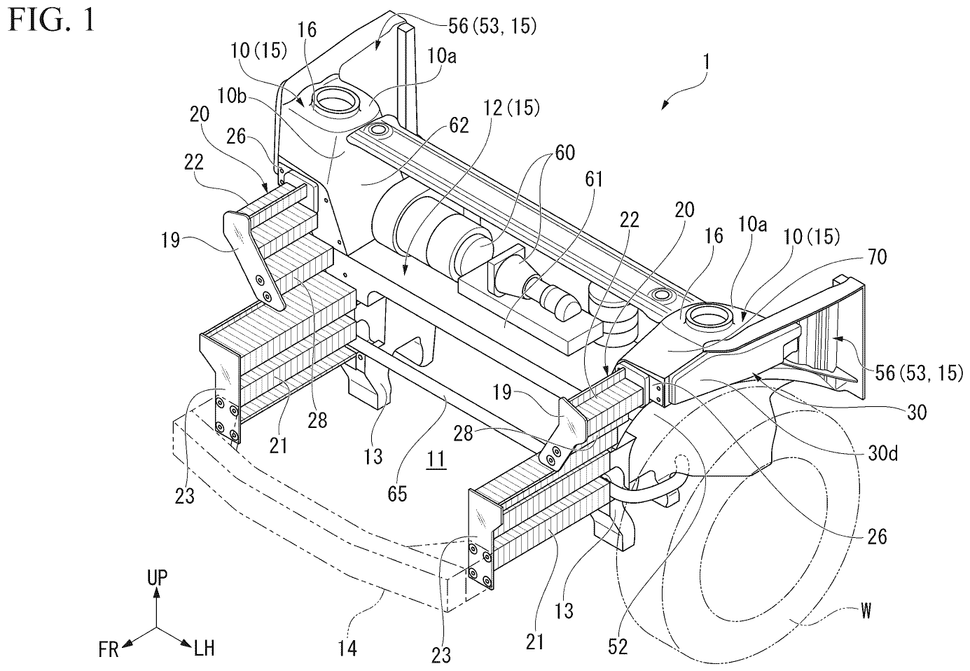

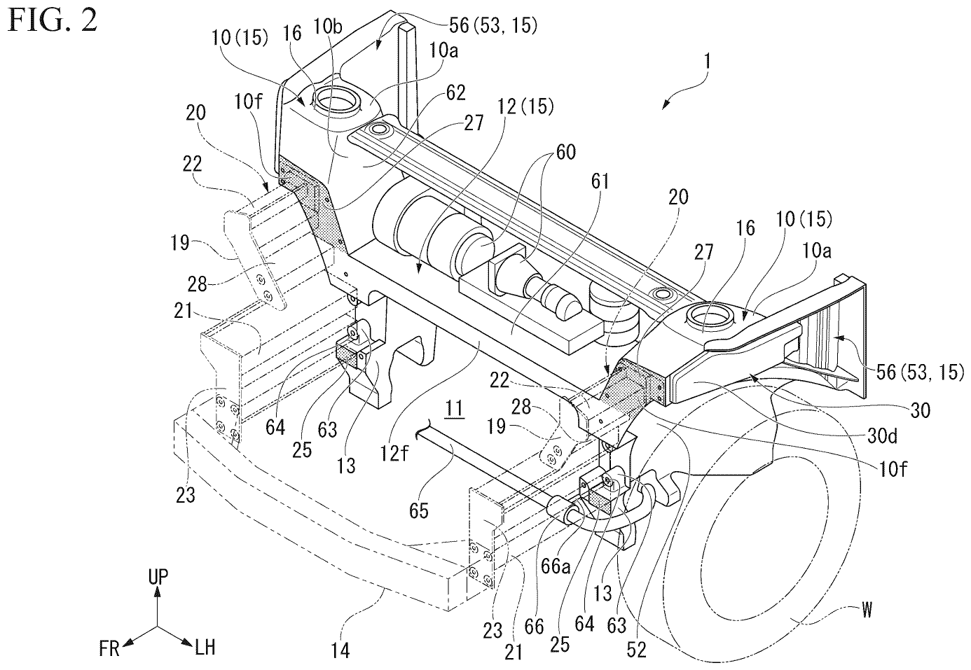

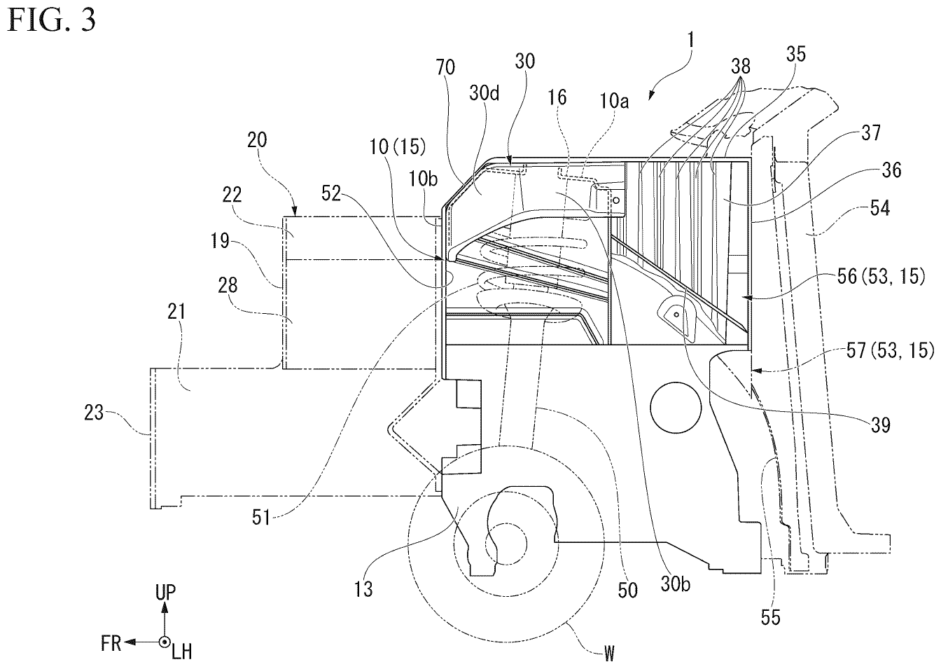

FIG. 1 is a perspective view of a front portion of the vehicle 1 of the embodiment. FIG. 2 is a perspective view, similar to FIG. 1, in which some members in FIG. 1 (a load-receiving member 20 described below) are shown in virtual lines. In addition, FIG. 3 is a side view when a front portion of the vehicle 1 is seen from an outer side in a vehicle width direction (a left side of the vehicle 1).

Reference sign 10 in FIG. 1 and FIG. 2 designates a pair of damper housings disposed on both left and right sides of a front compartment 11 in front of a driver's seat at an interval. The damper housing 10 has an upper wall 10a having a damper connecting portion 16, and a cover wall 10b extending downward from a circumferential edge (front and rear edge portions and an inner edge portion in the vehicle width direction) of the upper wall 10a. The damper housings 10 are open downward. In addition, a horizontal cross section of the damper housings 10 is open outward from the vehicle width direction. Hereinafter, an area of the damper housing 10 that opens outward from the vehicle width direction is referred to as “an opening portion 52.” A damper 50, a coil spring 51, or the like (see FIG. 3) of the front suspension is disposed in a space portion surrounded by the upper wall 10a and the cover wall 10b. An upper end portion of the damper 50 is connected to the damper connecting portion 16 of the upper wall 10a.

The left and right damper housings 10 are connected to each other by a lower connecting beam 12 (connecting beam) extending in the vehicle width direction. The lower connecting beam 12 is disposed on a lower front side of the vehicle compartment. The lower connecting beam 12 is formed in a substantially rectangular parallelepiped shape with a rectangular cross section extending in the vehicle width direction. Substantially U-shaped axle insertion blocks 13, through which axles of front wheels W corresponding to left and right sides are inserted, are continuously provided on lower surface sides of left and right side portions of the lower connecting beam 12.

In addition, a load transmission portion 53 extending toward the rear of the vehicle is continuously provided on a rear portion of each of the left and right damper housings 10. The load transmission portion 53 has an upper side load transmission portion 56 configured to connect the damper housings 10 corresponding to left and right sides to front pillars 54 on the same left and right sides, and a lower side load transmission portion 57 configured to connect the damper housings 10 to a dashboard panel 55. The lower side load transmission portion 57 is continuously provided on a lower region of the upper side load transmission portion 56. The front pillars 54 are disposed on left and right end portions of a front side of the vehicle compartment, and provided along front edge portions of front doors (not shown). In addition, the dashboard panel 55 is a panel member disposed to partition the vehicle compartment and the front compartment 11, and the left and right end portions are connected to the front pillars 54 corresponding to the left and right sides.

The left and right damper housings 10, the load transmission portion 53, and the lower connecting beam 12 are made of aluminum alloy casting parts.

In the embodiment, the casting parts consisting of the damper housings 10, the load transmission portion 53, and the lower connecting beam 12 constitute a suspension support structure 15. In addition, in the embodiment, the front pillars 54 constitute a vehicle compartment front member of an upper region of the vehicle compartment, and the dashboard panel 55 constitutes a vehicle compartment front member of a lower region of the vehicle compartment.

In addition, the load-receiving member 20 extending substantially in the vehicle forward/rearward direction is connected to each front surface side of the left and right damper housings 10. The left and right load-receiving members 20 are formed roughly symmetrically. The load-receiving member 20 is constituted by aluminum alloy casting parts.

Left and right side edge portions of a bumper beam 14 disposed on a front portion of the vehicle 1 are connected to front surfaces of the left and right load-receiving members 20 near the lower portions, respectively. The bumper beam 14 extends horizontally substantially in the vehicle width direction, and the back surface (rear surface) sides of the left and right side edge portions are connected to the corresponding front end portions of the load-receiving member 20.

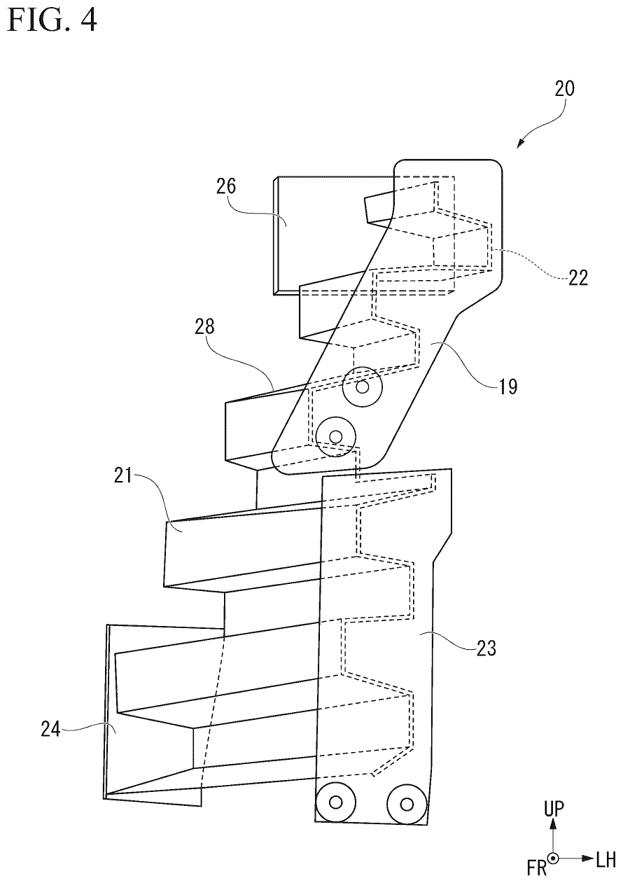

FIG. 4 is a front view when the load-receiving member 20 is seen from a side in front of the vehicle.

As shown in FIG. 1 and FIG. 4, the load-receiving member 20 includes a lower side load-receiving portion 21 in which a plate-shaped wall portion extending approximately along the vehicle forward/rearward direction is bent in a crank shape in the upward/downward direction and the leftward/rightward direction and connected thereto, and an upper side load-receiving portion 22 in which a plate-shaped wall portion extending approximately along the vehicle forward/rearward direction is bent in a crank shape in the upward/downward direction and the leftward/rightward direction and connected thereto. The upper side load-receiving portion 22 is located above the lower side load-receiving portion 21 and on the outer side the vehicle width direction.

The bent shape of the lower side load-receiving portion 21 or the upper side load-receiving portion 22 may be approximately L-shaped or channel-shaped, or may include a partially curved portion.

A plate-shaped load input wall 23 extending in a direction crossing (a direction substantially perpendicular to) the vehicle forward/rearward direction is provided on the front end portion of the lower side load-receiving portion 21. The bumper beam 14 is fastened and fixed to a front surface of the load input wall 23. In addition, a plate-shaped lower side load transmission wall 24 extending in a direction crossing (a direction substantially perpendicular to) the vehicle forward/rearward direction is provided on a rear end portion of the lower side load-receiving portion 21. A rear surface of the lower side load transmission wall 24 is fastened and fixed to a lower side front surface of a side portion of the lower connecting beam 12 (a front surface of a second load-receiving wall 25 described below).

The load input wall 23 is disposed at a position in the front end portion of the lower side load-receiving portion 21, where it wraps around at least the connecting portion of the bumper beam 14 in the upward/downward direction.

The upper side load-receiving portion 22 is shorter in length from front to rear than the lower side load-receiving portion 21, and its front end portion is located further rearward in the vehicle than the lower side load-receiving portion 21.

The lower side load-receiving portion 21 and the upper side load-receiving portion 22 are connected by a plate-shaped connecting wall portion 28. The connecting wall portion 28 continuously connects the lower side load-receiving portion 21 disposed below on the inner side in the vehicle width direction and the upper side load-receiving portion 22 disposed on the outer side in the vehicle width direction in the vehicle forward/rearward direction. Further, the connecting wall portion 28 is formed to have approximately the same length as the upper side load-receiving portion 22 in the vehicle forward/rearward direction, and continuously connects approximately the rear half region of the lower side load-receiving portion 21 to the upper side load-receiving portion 22.

A plate-shaped front end wall 19 extending in a direction crossing (a direction substantially perpendicular to) the vehicle forward/rearward direction is provided on the connecting wall portion 28 and the front end portion of the upper side load-receiving portion 22. In addition, a plate-shaped upper side load transmission wall 26 (load transmission wall) extending in a direction crossing (a direction substantially perpendicular to) the vehicle forward/rearward direction is provided on the rear end portion of the upper side load-receiving portion 22. The rear surface of the upper side load transmission wall 26 is fastened and fixed to a front surface of the damper housings 10 corresponding to the left and right sides (a front surface of a first load-receiving wall 27 described below). The upper side load transmission wall 26 (load transmission wall) is disposed at a position in the rear end portion of the upper side load-receiving portion 22, where it wraps around at least the joint portion (the first load-receiving wall 27) of the suspension support structure 15 in the upward/downward direction.

The upper side load-receiving portion 22 and the lower side load-receiving portion 21, together with the connecting wall portion 28, form a part of the front wheel house that covers the inside of the front wheels W in the vehicle width direction.

The connecting wall portion 28, like the lower side load-receiving portion 21 or the upper side load-receiving portion 22, is configured such that the plate-shaped wall portion extending roughly in the vehicle forward/rearward direction is continuously bent in a crank shape in the upward/downward direction and the leftward/rightward direction. In the embodiment, the connecting wall portion 28 also has an open cross-sectional shape that is open in the direction crossing the vehicle forward/rearward direction.

However, the connecting wall portion 28 does not have to be bent like a crank, but may be a flat plate, or a plate with a partially bent or curved shape.

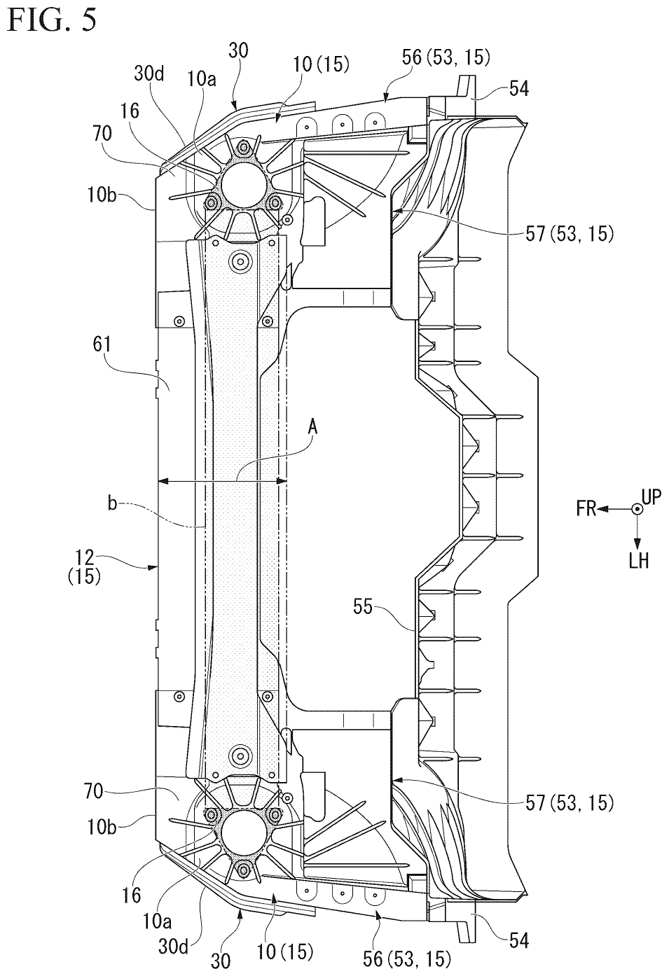

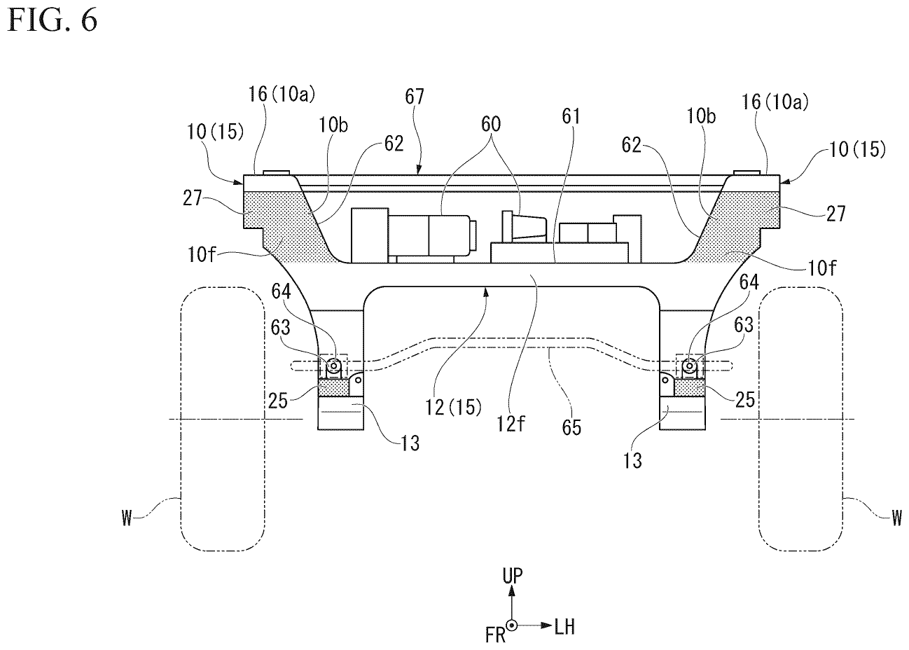

FIG. 5 is a plan view when a region of the front portion of the vehicle 1 behind the load-receiving member 20 is seen from above, and FIG. 6 is a front view of the suspension support structure 15.

As shown in FIG. 2 and FIG. 6, the front surface of the lower connecting beam 12 and the front surface of the cover wall 10b of the left and right damper housings 10 are continuous flat surfaces facing directly toward the front of the vehicle. Some of these flat surfaces constitutes the front surface of the first load-receiving wall 27 to which the upper side load transmission wall 26 of the rear portion of the load-receiving member 20 is joined in face-to-face contact. In addition, flat surfaces facing directly toward the vehicle front surface are also formed on the lower side front surfaces of the left and right side portions of the lower connecting beam 12. The flat surfaces constitute the front surface of the second load-receiving wall 25 to which the lower side load transmission wall 24 of the rear portion of the load-receiving member 20 is joined in face-to-face contact.

In the embodiment, the front surface of the lower connecting beam 12 constitutes a beam front surface portion 12f, and the front surfaces of the cover walls 10b of the damper housings 10 constitute a housing front surface portion 10f. The beam front surface portion 12f and the housing front surface portion 10f both extend in a direction substantially perpendicular to the vehicle forward/rearward direction. The beam front surface portion 12f and the housing front surface portion 10f are formed to be flush with each other while facing toward the front of the vehicle.

In addition, the front surface of the lower connecting beam 12 is formed flat. As shown in FIG. 6, the front surface of the lower connecting beam 12 is defined as an auxiliary equipment mounting portion 61 configured to allow mounting of auxiliary equipment 60 such as a heat exchanger, a compressor, a power control unit (ECU), and a power unit (a unit combining the ECU and the battery). The lower connecting beam 12 is disposed between the left and right damper housings 10 and is connected to the inner wall in the vehicle width direction of the cover wall 10b of the left and right damper housings 10. Hereinafter, the inner wall of the cover wall 10b in the vehicle width direction is referred to as “a vertical wall portion 62.”

The auxiliary equipment mounting portion 61 of the lower connecting beam 12 is disposed below each of the damper connecting portions 16 of the left and right damper housings 10. The vertical wall portion 62 of the damper housing 10 extends downward from the vicinity of the inner edge portion of each of the damper connecting portions 16 of the left and right damper housings 10 in the vehicle width direction (the inner edge portion of the upper wall 10a in the vehicle width direction). Then, the vertical wall portion 62 connects the vicinity of the inner edge portion of the damper connecting portion 16 in the vehicle width direction and the auxiliary equipment mounting portion 61. The left and right vertical wall portions 62 slope downwardly inward in the vehicle width direction from the vicinity of the inner edge portion of the damper connecting portion 16 in the vehicle width direction toward the auxiliary equipment mounting portion 61.

As shown in FIG. 5, the lower connecting beam 12 is disposed to at least partially overlap a strip area b connecting extension portions of the damper connecting portions 16 of the left and right damper housings 10 in the vehicle forward/rearward direction. In the embodiment, the strip area b connecting the extension portions of the left and right damper connecting portions 16 is set to be located inside a longitudinal width A of the lower connecting beam 12 when seen in a plan view.

In addition, as shown in FIG. 2 and FIG. 6, the axle insertion block 13 extending downward is provided integrally with the vicinity of the connecting portion of the left and right damper housings 10 and the lower connecting beam 12. The second load-receiving wall 25 described above is provided on the front surface near below each of the left and right axle insertion blocks 13. In addition, a boss portion 63 extending in the vehicle forward/rearward direction is provided on the upper portion of the second load-receiving wall 25 of the front surface of each of the axle insertion blocks 13. A support hole 64 is formed in the front surface of the boss portion 63. A stabilizer-supporting shaft portion 66a is inserted into the support hole 64. The stabilizer-supporting shaft portion 66a is provided on a locking block 66 of a stabilizer 65. The locking block 66 is attached to a load portion of the stabilizer 65 extending in the vehicle width direction.

In the embodiment, the support hole 64 constitutes a stabilizer support portion configured to support a part of the stabilizer 65. The support hole 64, which is the stabilizer support portion, is provided in the vicinity of the connecting portion of the damper housings 10 and the lower connecting beam 12.

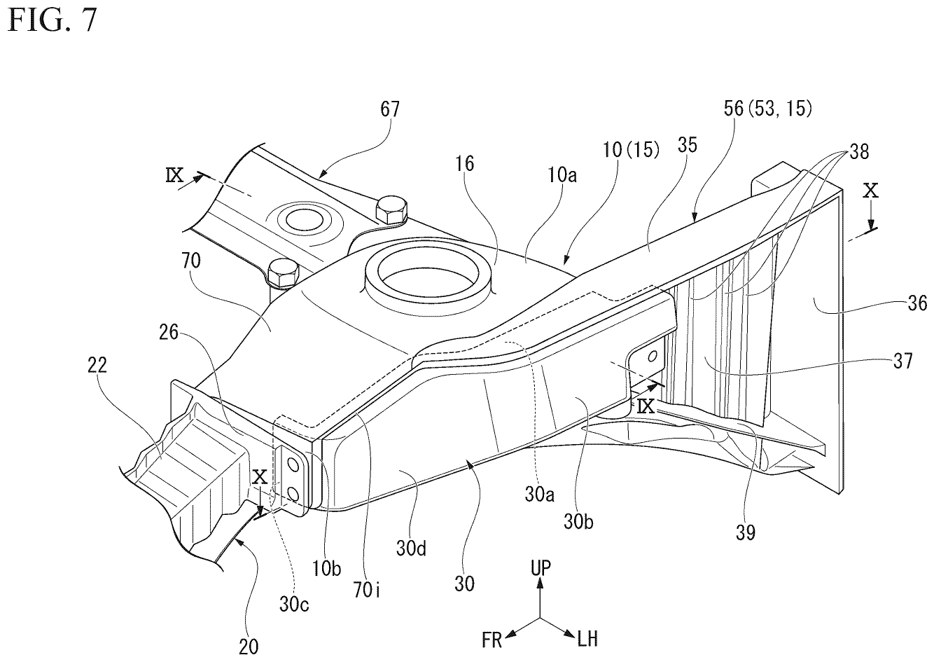

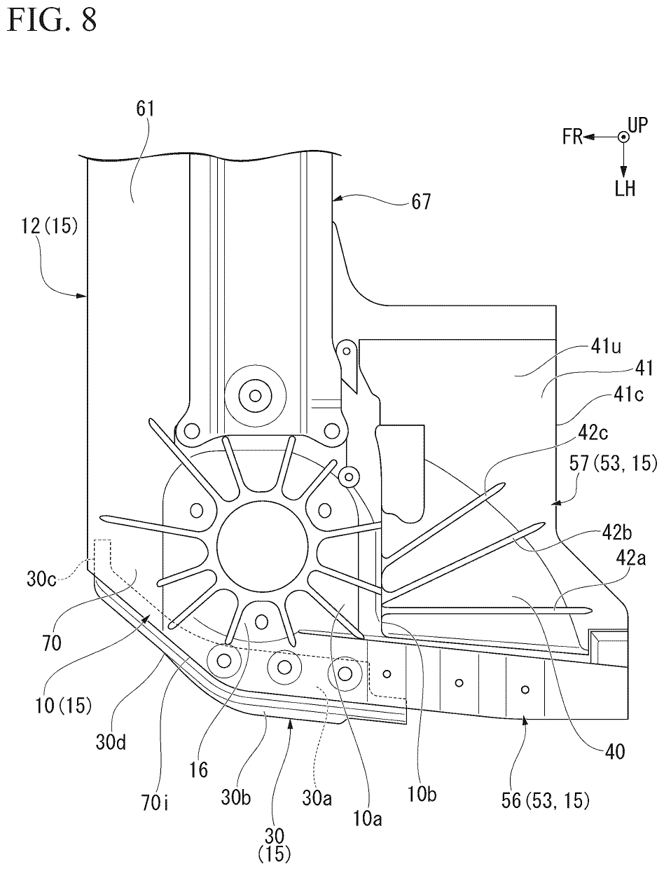

FIG. 7 is an enlarged perspective view of a part of the suspension support structure 15 on the left side, and FIG. 8 is enlarged plan view of the part of the suspension support structure 15 on the left side.

As shown in FIG. 1, FIG. 2 and FIG. 5 to FIG. 8, the upper walls 10a of the left and right damper housings 10 (the portions in the vicinity of the damper connecting portion 16) are connected by an upper connecting beam 67. The upper connecting beam 67 is formed of an aluminum alloy plate member having a roughly hat-shaped cross section. The upper connecting beam 67 extends substantially in the vehicle width direction, generally parallel to the auxiliary equipment mounting portion 61 (front surface), above the auxiliary equipment mounting portion 61 (front surface) of the lower connecting beam 12. As shown in FIG. 5, the longitudinal width of the upper connecting beam 67 is smaller than the longitudinal width A of the lower connecting beam 12. The upper connecting beam 67 is disposed to overlap the lower connecting beam 12 when seen in a plan view.

As shown in FIG. 6, the upper connecting beam 67, together with the left and right damper housings 10 and the lower connecting beam 12, form a closed cross section that is approximately rectangular when seen in a front view.

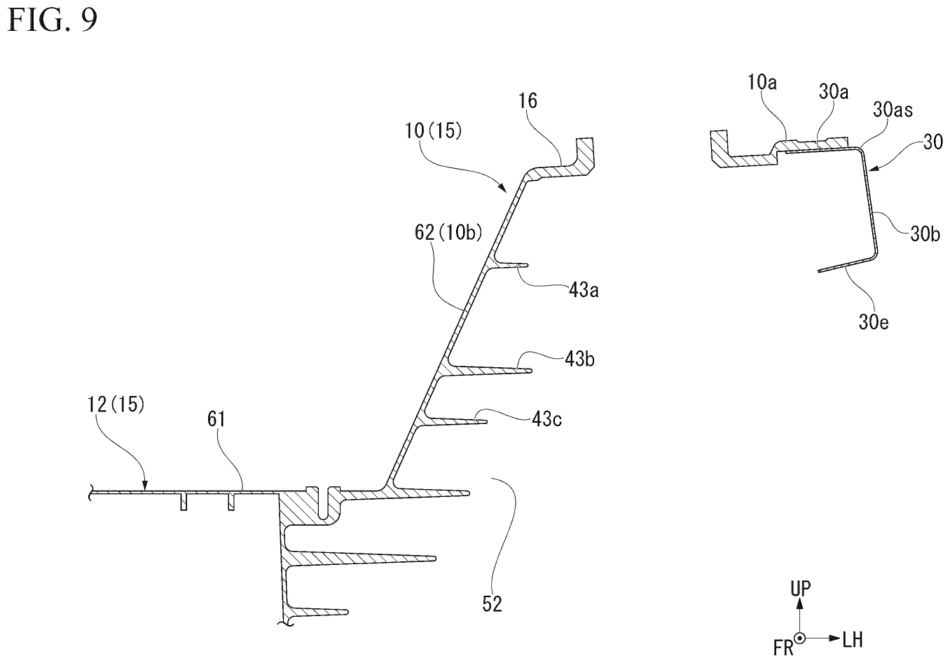

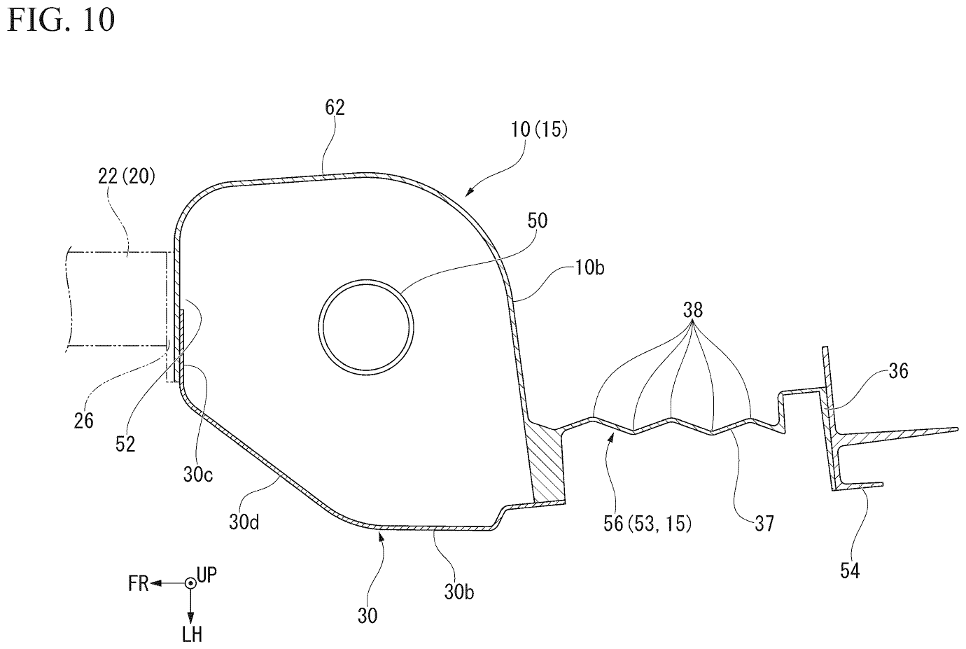

In addition, FIG. 9 is a cross-sectional view along line IX-IX in FIG. 7, and FIG. 10 is a cross-sectional view along line X-X in FIG. 7.

As shown in FIG. 9 and FIG. 10, the upper walls 10a and the cover walls 10b of the damper housings 10 form the opening portion 52 that opens outward and downward in the vehicle width direction. An outer upper region of the opening portion 52 in the vehicle width direction is covered with a reinforcement member 30. The reinforcement member 30 is made of a metal material such as steel or titanium alloy that has a higher tensile strength than the aluminum alloy that forms the damper housings 10. The reinforcement member 30 is fixed to the damper housings 10 corresponding to the left and right sides by bolt fastening, welding, or the like.

In the embodiment, although the reinforcement member 30 is provided to cover only the outer upper region of the opening portion 52 in the vehicle width direction, the reinforcement member 30 may be provided to cover the intermediate region or the lower region of the opening portion 52 in the upward/downward direction on the outer side in the vehicle width direction. That is, the reinforcement member 30 may be provided to cover at least a portion of the opening portion 52 on the outer side in the vehicle width direction of the open cross section of the damper housings 10.

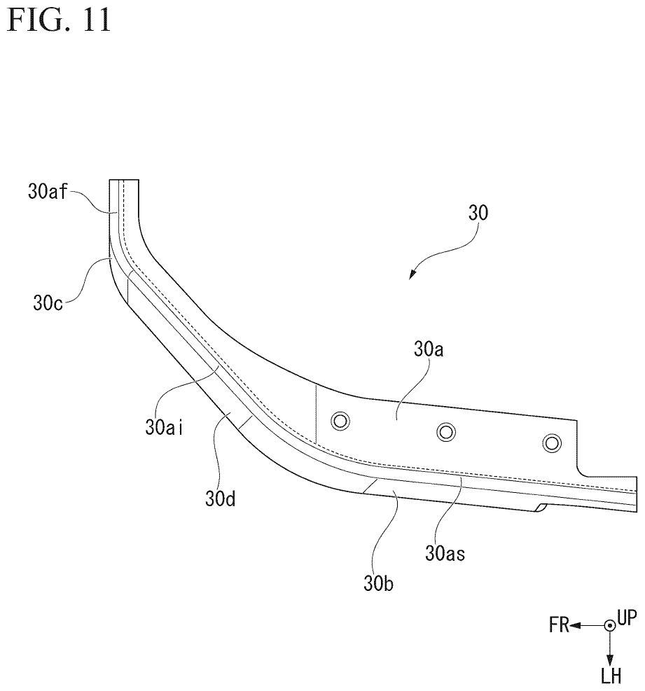

FIG. 11 is a perspective view when the reinforcement member 30 is seen from above.

The reinforcement member 30 includes an upper wall portion 30a extending along the side edge of the upper wall 10a of the damper housing 10 and joined to the lower surface of the upper wall 10a. The upper wall portion 30a has a lateral side 30as extending in the vehicle forward/rearward at its outer side end in the vehicle width direction, a front side 30af extending in the vehicle width direction at its front side end in the vehicle forward/rearward direction, and an inclined side 30ai that connects the lateral side 30as and the front side 30af. The inclined side 30ai is inclined from an outer side end of the front side 30af in the vehicle width direction toward a front end portion of the lateral side 30as. The inclined side 30ai is inclined outward in the vehicle width direction toward the rear of the vehicle.

The upper wall portion 30a of the reinforcement member 30 is inclined downward toward the front of the vehicle in a region in front of the connecting portion of the lateral side 30as and the inclined side 30ai.

In addition, the reinforcement member 30 includes a sidewall portion 30b extending to be bent or curved downward from the lateral side 30as (outer position in the vehicle width direction) of the upper wall portion 30a, a front wall portion 30c extending to be bent or curved downward from the front side 30af (front side of the vehicle) of the upper wall portion 30a, and an inclined wall 30d extending to be bent or curved downward from the inclined side 30ai of the upper wall portion 30a. The front end portion of the inclined wall 30d is connected to the outer end portion of the front wall portion 30c in the vehicle width direction, and the rear end portion of the inclined wall 30d is connected to the front end of the sidewall portion 30b. As shown in FIG. 8, the inclined wall 30d is inclined outward in the vehicle width direction from a position forward of the vehicle toward the rear of the vehicle relative to the damper connecting portion 16. In addition, the reinforcement member 30 includes a lower wall portion 30e (see FIG. 9) connected to lower ends of the sidewall portion 30b, the inclined wall 30d, and the front wall portion 30c. The lower wall portion 30e extends below the upper wall portion 30a so as to be approximately parallel to the upper wall portion 30a. As shown in FIG. 3, the upper end portion of the inclined wall 30d is inclined downward toward the front of the vehicle, following the inclination of the front region of the upper wall portion 30a.

Here, as shown in FIG. 3 and FIG. 7, the upper wall 10a of the left and right damper housings 10 includes the damper connecting portion 16 to which the upper end portion of the damper 50 is connected, and a forward inclined portion 70 inclined downward from the front end portion of the damper connecting portion 16 toward the front of the vehicle. The damper connecting portion 16 connected to the rear end portion of the forward inclined portion 70 is inclined downward toward the rear of the vehicle.

The upper wall portion 30a of the reinforcement member 30 is joined to the lower surfaces of the outer edge portions in the vehicle width direction of the damper connecting portion 16 and the forward inclined portion 70 of the upper walls 10a of the damper housings 10.

As shown in FIG. 10, the reinforcement member 30 has the front wall portion 30c and the sidewall portion 30b joined to the front edge portion and the rear edge portion of the opening portion 52 of the damper housings 10. Accordingly, the opening portion 52 of the damper housings 10 is closed by the reinforcement member 30 in the cross section in the horizontal direction including the inclined wall 30d.

In addition, as shown in FIG. 7 and FIG. 8, the forward inclined portion 70 connected to the front portion of the damper connecting portion 16 of the damper housings 10 has a lateral side on the outer side in the vehicle width direction that is inclined when seen in a plan view. The lateral side of the forward inclined portion 70 is inclined outward in the vehicle width direction from the front end portion toward the rear of the vehicle. This inclined lateral side of the forward inclined portion 70 will hereinafter be referred to as “the upper wall inclined portion 70i.”

As shown in FIG. 8, the inclined wall 30d of the reinforcement member 30, when seen in a plan view, is positioned so as to protrude outward and forward in the vehicle width direction than the upper wall inclined portion 70i. That is, the inclined wall 30d of the reinforcement member 30 protrudes outward and forward in the vehicle width direction relative to the upper wall inclined portion 70i of the damper housings 10.

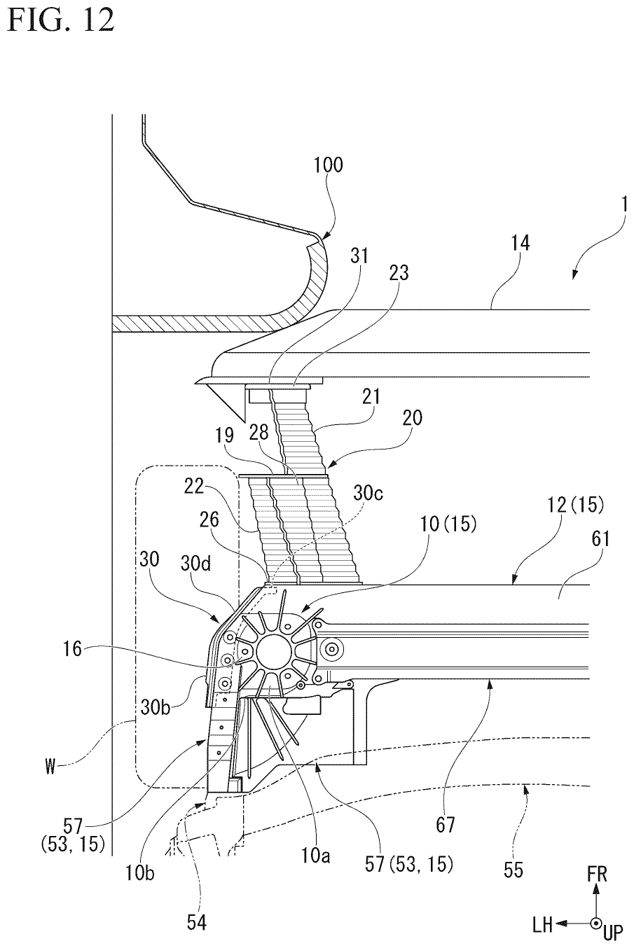

FIG. 12 is a plan view of the front portion of the vehicle 1. In FIG. 12, a load input object 100 is shown as a schematic cross section when an impact load is input from the front of the vehicle. The load input object 100 is located offset to one side in the vehicle width direction relative to the front of the vehicle.

As shown in FIG. 12, the reinforcement member 30 is disposed such that at least a part of the inclined wall 30d overlaps a connecting portion 31 between the load-receiving member 20 (the lower side load-receiving portion 21) connected to the front portion of the damper housing 10 and the bumper beam 14 of the vehicle front portion on sides in front of and behind the vehicle when seen in a plan view. In addition, as shown in FIG. 7 and FIG. 12, at least a part of the upper side load transmission wall 26 (load transmission wall) provided on the rear end portion of the upper side load-receiving portion 22 is located at a position that overlaps the front wall portion 30c of the reinforcement member 30 in the vehicle forward/rearward direction. The upper side load transmission wall 26 (load transmission wall) is joined to the front wall portion 30c of the damper housings 10 and the reinforcement member 30 while overlapping the front surface of the cover wall 10b of the damper housing 10.

As shown in FIG. 5 and FIG. 8, the lower connecting beam 12 extending in the vehicle width direction is connected to inner end portions of the left and right damper housings 10 in the vehicle width direction. The reinforcement member 30 fixed to each of the left and right damper housings 10 is disposed such that each of the inclined walls 30d overlaps the extension region of the lower connecting beam 12 in the vehicle forward/rearward direction (in FIG. 5, a region drawn by an arrow of the longitudinal width A) in the vehicle forward/rearward direction.

In the embodiment, the entire inclined wall 30d of each of the reinforcement members 30 is disposed so as to overlap the extension region of the lower connecting beam 12 in the vehicle forward/rearward direction, but the inclined wall 30d of each of the reinforcement members 30 may be disposed so that only a portion thereof overlaps the extension region of the lower connecting beam 12 in the vehicle forward/rearward direction.

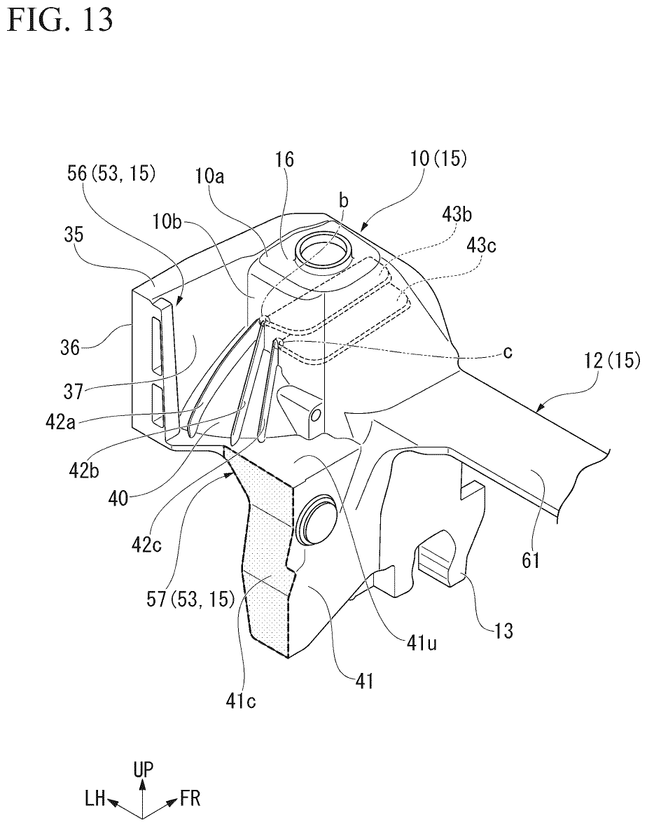

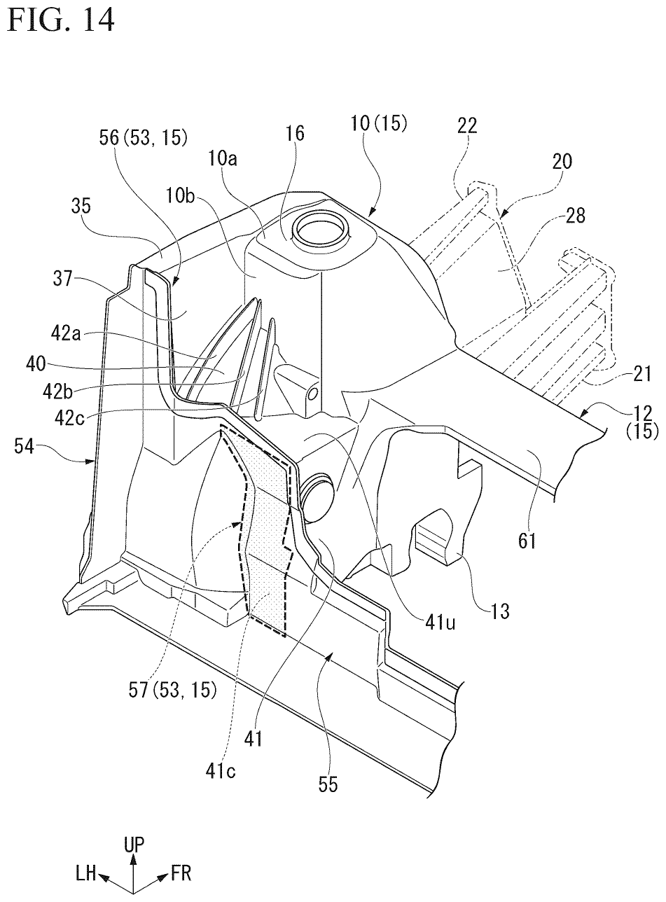

FIG. 13 is a perspective view when the suspension support structure 15 is from the vehicle compartment side. In addition, FIG. 14 is a perspective view when the suspension support structure 15 to which the dashboard panel 55 is attached is seen from the vehicle compartment side.

As shown in FIG. 3, FIG. 7, FIG. 13, FIG. 14, and the like, the upper side load transmission portion 56 connected to the rear portion of each of the left and right damper housings 10 includes a band-shaped upper frame portion 35 extending from the outer edge portion in the vehicle width direction of the upper wall 10a of the damper housing 10 toward the rear of the vehicle, a rear frame portion 36 extending to be bend downward from the rear end portion of the upper frame portion 35, and a vertical wall portion 37 connected to the inner edge portions in the vehicle width direction of the upper frame portion 35 and the rear frame portion 36. The rear frame portion 36 is attached to the front pillars 54 corresponding to the left and right sides.

As shown in FIG. 3, the vertical wall portion 37, when seen in a side view, is formed in a roughly trapezoidal shape with its vertical width gradually increasing from the front to the rear of the vehicle. In addition, the vertical wall portion 37 is formed by bending the horizontal cross section into a wave shape as shown in FIG. 10. Each of apex portions 38 of the bend in this wave shape extends linearly in the upward/downward direction. In addition, the apex portions 38 of the wave-shaped bend are spaced at approximately regular intervals in the vehicle forward/rearward direction. The apex portions 38 of the wave shape bend constitute a fracture inducing portion that induces fracture (or deformation) of the upper side load transmission portion 56 when an impact load greater than a specified value is input to the upper side load transmission portion 56. Hereinafter, the apex portions 38 of the wave-shaped bend are referred to as “a fracture inducing portion 38.”

The fracture inducing portion 38 of the vertical wall portion 37 is configured so that, when an impact load is input from the front of the vehicle and biased toward one side in the vehicle width direction, the impact load induces fracture of the vertical wall portion 37 on the side where the load is input, and when an impact load is input from the front of the vehicle and not biased in the vehicle width direction, the vertical wall portion 37 does not fracture. That is, only when an impact load is input from the front of the vehicle while being offset in the vehicle width direction, the upper side load transmission portion 56 (the vertical wall portion 37) on the side where a large load is input is configured to fracture at the fracture inducing portion 38.

As shown in FIG. 3 and FIG. 7, the lower surface of the vertical wall portion 37 slopes downward from the front end portion toward the rear of the vehicle. Slightly above the lower surface of the vertical wall portion 37, inclined ribs 39 protrude along the lower surface and slope downward from the vehicle front end side to the rear side. The inclined ribs 39 protrude outward from the vertical wall portion 37 in the vehicle width direction. The protrusion height of the inclined ribs 39 is higher than the height in the vehicle width direction of the bend of the wave shape of the vertical wall portion 37 (the height from the apex portion that protrudes inward in the vehicle width direction to the apex portion that protrudes outward in the vehicle width direction).

In addition, as shown in FIG. 13 and FIG. 14, the lower side load transmission portion 57 connected to the rear portion of each of the left and right damper housings 10 includes a curved wall 40 connected to the lower surface of the vertical wall portion 37 of the upper side load transmission portion 56 and the rear surface of the cover wall 10b of the damper housing 10, and a lower block 41 connected to the lower end of the curved wall 40. The curved wall 40 is formed to be three-dimensionally curved so that the front surface side forms an upwardly convex spherical surface shape. A plurality of outer reinforcement ribs 42a, 42b and 42c extending to connect the rear surface of the cover wall 10b of the damper housing 10 and the front surface of the lower block 41 are provided on the front surface of the curved wall 40.

As shown in FIG. 9, a plurality of inner reinforcement ribs 43a, 43b and 43c are provided on the inner side of the cover wall 10b of the damper housing 10, and are arranged continuously from the front wall portion to the sidewall portion and the rear wall portion of the cover wall 10b. As shown in FIG. 13, among these, the rear end portions of the two inner reinforcement ribs 43b and 43c are connected to the two outer reinforcement ribs 42b and 42c via the cover wall 10b of the damper housing 10. The inner reinforcement ribs 43b and 43c and the outer reinforcement ribs 42b and 42c slope downward from the front to the rear of the vehicle.

In FIG. 13, reference sign b designates a connecting portion of the inner reinforcement rib 43b and the outer reinforcement rib 42b on the cover wall 10b, and reference sign c designates a connecting portion of the inner reinforcement rib 43c and the outer reinforcement rib 42c on the cover wall 10b.

The lower block 41 bulges out from the rear portion of the axle insertion block 13 toward the rear of the vehicle. The lower block 41 is disposed at a rear position of the second load-receiving wall 25 on the front surface side of the axle insertion block 13. The lower block 41 includes a flat upper surface 41u connected to the lower end of the curved wall 40 and the cover wall 10b of the damper housing 10, and a connecting surface 41c directed toward the rear of the vehicle. As shown in FIG. 14, the connecting surface 41c is connected to the front surface of the dashboard panel 55.

The lower side load transmission portion 57 of the load transmission portion 53 is disposed behind the lower side load-receiving portion 21 of the load-receiving members 20 corresponding to the left and right sides and in a position overlapping in the upward/downward direction. In addition, the upper side load transmission portion 56 of the load transmission portion 53 is disposed behind the upper side load-receiving portion 22 of the load-receiving members 20 corresponding to the left and right sides and in a position overlapping in the upward/downward direction.

As described above, the vehicle front structure of the embodiment includes the reinforcement member 30 configured to cover at least a portion of the opening portion 52 on the outer side in the vehicle width direction of the open cross section of the damper housing 10. For this reason, deformation of the opening portion 52 of the damper housing 10 can be suppressed by the reinforcement member 30.

Accordingly, when the vehicle front structure of the embodiment is employed, it is possible to achieve improvement in the strength and rigidity of the damper housings 10 against the input load while suppressing an increase in the wall thickness of the member.

In addition, in the vehicle front structure of the embodiment, the reinforcement member 30 has the inclined wall 30d that is inclined outward in the vehicle width direction from a position further forward of the vehicle than the damper connecting portion 16 toward the rear of the vehicle. For this reason, when an impact load is input to the front portion of the damper housings 10 from the front side of the vehicle, the deformation of the opening portion 52 of the damper housing 10 is suppressed by the reinforcement member 30, and the impact load input to the front portion of the reinforcement member 30 is smoothly transmitted outward in the vehicle width direction and rearward of the vehicle 1 through the inclined wall 30d of the reinforcement member 30.

Accordingly, when the vehicle front structure of the embodiment is employed, it is possible to efficiently transmit the impact load input to the front portion of the damper housings 10 to the frame members, such as the front pillars 54, located outside and on the rear side in the vehicle width direction.

In addition, in the vehicle front structure of the embodiment, the reinforcement member 30 includes the upper wall portion 30a and the inclined wall 30d. The reinforcement member 30 extends along the upper wall 10a of the damper housings 10 and is joined to the upper wall 10a. Then, the inclined wall 30d extends to be bent or curved downward from the end portion of the upper wall portion 30a. Accordingly, a ridge portion with high rigidity is formed along the extension direction of the inclined wall 30d between the upper wall portion 30a and the inclined wall 30d.

Accordingly, when the configuration is employed, the high rigidity ridge portion formed between the upper wall portion 30a and the inclined wall 30d enables the impact load input to the front portion of the damper housings 10 to be transmitted more smoothly to the outer side and the rear of the vehicle 1 in the vehicle width direction.

Further, in the vehicle front structure of the embodiment, the inclined wall 30d of the reinforcement member 30 is located so as to overlap the connecting portion 31 between the load-receiving member 20 and the bumper beam 14 in the vehicle forward/rearward direction when seen in a plan view. When an impact load is input from the front to a position offset to one side in the leftward/rightward direction of the vehicle 1 (see the position of the load input object 100 in FIG. 12), the load is transmitted to one of the load-receiving members 20 through the connecting portion 31 with the bumper beam 14. Here, the inclined wall 30d of the reinforcement member 30 is located to overlap the connecting portion 31 between the load-receiving member 20 and the bumper beam 14 in the vehicle forward/rearward direction when seen in a plan view, so that the direction of action of the impact load input to the bumper beam 14 is deflected inward in the vehicle width direction through the inclined wall 30d. As a result, the front portion of vehicle 1 moves inward to retreat (away) from the input position of the impact load in the vehicle width direction.

Accordingly, when the vehicle front structure of the configuration is employed, it is possible to reduce the impact load input to the vehicle front portion.

In addition, in the vehicle front structure of the embodiment, the left and right damper housings 10 are connected by a connecting beam substantially extending in the vehicle width direction (the lower connecting beam 12 and the upper connecting beam 67). Then, each of the left and right reinforcement members 30 is disposed such that the inclined wall 30d overlaps the extension region in the vehicle forward/rearward direction and at least a part thereof in the vehicle forward/rearward direction of the connecting beam (the lower connecting beam 12 and the upper connecting beam 67). For this reason, when a vertical load input to the suspension or an impact load from the front portion of the vehicle acts on the damper housings 10, the deformation of the left and right damper housings 10 caused by the load input can be suppressed by the connecting beam. In addition, when an impact load is input from the front of the vehicle to the inclined wall 30d of the reinforcement member 30, the impact load can be efficiently deflected in the extension direction of the connecting beam via the inclined wall 30d.

Accordingly, when the vehicle front structure of the configuration is employed, it is possible to deflect and transmit the input impact load to the connecting beam.

In addition, in the vehicle front structure of the embodiment, the connecting beam includes the upper connecting beam 67 configured to connect the damper connecting portions 16 of the left and right damper housings 10, and the lower connecting beam 12 configured to connect the left and right damper housings 10 at the position below the reinforcement member 30. For this reason, the upper connecting beam 67 and the lower connecting beam 12 form the closed cross-sectional structure with high rigidity together with the left and right damper housings 10.

Accordingly, when the vehicle front structure of the configuration is employed, it is possible for the damper housings 10 to support the load input thereto with high rigidity.

Further, in the configuration, when an impact load is input to the inclined wall 30d of the reinforcement member 30, the closed cross-sectional structure can suppress deformation of the upper connecting beam 67 and the lower connecting beam 12. Accordingly, when the configuration is employed, the load can be reliably transferred from the connecting beam to a wide range of parts of the vehicle.

In addition, in the vehicle front structure of the embodiment, the inclined wall 30d of the reinforcement member 30, when seen in a plan view, protrudes outward in the vehicle width direction and forward beyond the upper wall inclined portion 70i of the upper wall 10a of the damper housings 10. For this reason, when an impact load is input from the front of the vehicle, as a front object moves toward the upper wall inclined portion 70i of the damper housing 10, the inclined wall 30d of the reinforcement member 30 comes into contact with the object first.

Accordingly, when the vehicle front structure of the configuration is employed, the reinforcement member 30 can further suppress the deformation of the damper housings 10 when an impact load is input.

In addition, in the vehicle front structure of the embodiment, the front wall portion 30c and the sidewall portion 30b of the reinforcement member 30 are joined to the edge portion of the open cross section of the damper housings 10, so that the opening portion 52 of the damper housings 10 is blocked by the reinforcement member 30 in a horizontal cross section including the inclined wall 30d. For this reason, the front and rear of the inclined wall 30d of the reinforcement member 30 are connected to the edge portion of the open cross section of the damper housings 10, so that the reinforcement member 30 efficiently regulates the deformation of the open cross section (the opening portion 52) of the damper housings 10. That is, when an impact load is input to the front portion of the damper housings 10, the input impact load is released from the front wall portion 30c of the reinforcement member 30 through the inclined wall 30d and then through the sidewall portion 30b to the rear of the vehicle, thereby suppressing deformation of the damper housings 10.

Accordingly, when the vehicle front structure of the configuration is employed, it is possible to increase the strength and rigidity of the damper housings 10 while suppressing an increase in the wall thickness of the damper housings 10.

Further, in the vehicle front structure of the embodiment, the reinforcement member 30 is made of a metal material such as steel or titanium alloy that has higher tensile strength than the damper housings 10, which are made of an aluminum alloy. For this reason, when a large vertical load of the suspension or an impact load from the front of the vehicle is input to the damper housings 10, the deformation of the damper housings 10 can be more reliably regulated by the reinforcement member 30.

In addition, in the vehicle front structure of the embodiment, the load-receiving member 20 joined to the front portions of the left and right damper housings 10 includes the lower side load-receiving portion 21, the upper side load-receiving portion 22, and the connecting wall portion 28. The lower side load-receiving portion 21 has an open cross-section consisting of at least two surfaces and extending substantially in the vehicle forward/rearward direction, with the front portion joined to the bumper beam 14 and the rear portion joined to the suspension support structure 15. The front portion is joined to the bumper beam 14, and the rear portion is joined to the suspension support structure 15. The upper side load-receiving portion 22 has an open cross section consisting of at least two surfaces and extending substantially in the vehicle forward/rearward direction above the lower side load-receiving portion 21, and the rear portion is joined to the suspension support structure 15. The connecting wall portion 28 connects the lower side load-receiving portion 21 and the upper side load-receiving portion 22 in a continuous manner in the vehicle forward/rearward direction.

In the vehicle front structure of the configuration, when an impact load is input from the front of the vehicle, the load is input through the bumper beam 14 to the lower side load-receiving portion 21. A part of the load input to the front portion of the lower side load-receiving portion 21 is transmitted directly through the lower side load-receiving portion 21 to the suspension support structure 15 of the rear portion, and the other part is transmitted through the connecting wall portion 28 and the upper side load-receiving portion 22 to the suspension support structure 15 of the rear portion. Here, since the connecting wall portion 28 continuously connects the lower side load-receiving portion 21 and the upper side load-receiving portion 22 in the forward/rearward direction of the vehicle, the load is transmitted in a distributed manner over a wide range of the upper side load-receiving portion 22 in the forward/rearward direction.

When an impact load is input from the front of the vehicle to the front portion of the upper side load-receiving portion 22, a part of the load is transmitted through the upper side load-receiving portion 22 to the suspension support structure 15 of the rear portion, and the other part of the load is transmitted through the connecting wall portion 28 and the lower side load-receiving portion 21 to the suspension support structure 15 of the rear portion.

In the vehicle front structure of the embodiment, since the lower side load-receiving portion 21 and the upper side load-receiving portion 22, which transmit the impact load from the vehicle front portion to the rear suspension support structure 15, are open cross-sections (not closed cross-sections), partial rigidity differences are less likely to occur in almost the entire area in the vehicle upward/downward direction. For this reason, the load can be substantially uniformly transmitted to the entire areas of the lower side load-receiving portion 21, the connecting wall portion 28, and the upper side load-receiving portion 22.

Accordingly, when the vehicle front structure of the configuration is employed, if an impact load is input from the front of the vehicle, the lower side load-receiving portion 21, the connecting wall portion 28, and the upper side load-receiving portion 22 are deformed approximately evenly, thereby enabling the energy of the impact load to be absorbed efficiently.

In the vehicle front structure of the embodiment, the upper side load transmission wall 26 (load transmission wall) is further provided on the rear portion of, the upper side load-receiving portion 22, and the upper side load transmission wall 26 is joined to the damper housings 10 and the front wall portion 30c of the reinforcement member 30. For this reason, when the vehicle front structure of the configuration is employed, the impact load transmitted to the upper side load-receiving portion 22 can be efficiently transmitted to the damper housings 10 and the front wall portion 30c of the reinforcement member 30 through the upper side load transmission wall 26.

The present invention is not limited to the above-mentioned embodiment, and various design modifications are possible without departing from the spirit of the present invention. For example, in the embodiment, the upper connecting beam 67 that connects the upper walls 10a of the left and right damper housings 10 together is made of an aluminum alloy or the like, but the metal that forms the upper connecting beam 67 is not limited to the aluminum alloy. The upper connecting beam 67 may be formed of a metal material other than aluminum alloy, such as steel or the like.

In addition, in the embodiment, the upper connecting beam 67, which connects the upper walls 10a of the left and right damper housings 10, is constituted by the suspension support structure 15, which is an aluminum alloy casting part, and separate parts. However, the upper connecting beam 67 may be formed as an integral casting part with the suspension support structure 15. When the upper connecting beam 67 is formed integrally with the suspension support structure 15, it is possible to reduce the number of parts and to eliminate the need for complicated assembly work such as bolt fastening, welding, or the like.

When the upper connecting beam 67 is formed as a separate part from the suspension support structure 15 as described above, the auxiliary equipment 60 can be easily mounted on the auxiliary equipment mounting portion 61 of the lower connecting beam 12 with the upper connecting beam 67 removed. In addition, in this case, depending on the required strength or rigidity, the material of the upper connecting beam 67 can be optimally selected from steel, aluminum alloy, or the like.

In addition, in the embodiment, the upper walls 10a of the left and right damper housings 10 are connected by the upper connecting beam 67. However, it is not essential that the upper walls 10a of the left and right damper housings 10 be connected to each other by the upper connecting beam 67, and the upper connecting beam 67 does not necessarily have to be provided.

Further, in the embodiment, although the reinforcement member 30 is configured as one part made of a metal material, the reinforcement member 30 may be configured as multiple parts.

### BRIEF DESCRIPTION OF THE REFERENCE SYMBOLS

10 Damper housing
10a Upper wall
10b Cover wall
12 Lower connecting beam (connecting beam)
14 Bumper beam
15 Suspension support structure
16 Damper connecting portion
20 Load-receiving member
21 Lower side load-receiving portion
22 Upper side load-receiving portion
26 Upper side load transmission wall (load transmission wall)
28 Connecting wall portion
30 Reinforcement member
30a Upper wall portion
30b Sidewall portion
30c Front wall portion
30d Inclined wall
31 Connecting portion
67 Upper connecting beam (connecting beam)
70i Upper wall inclined portion

What is claimed is:

1. A vehicle front structure comprising a suspension support structure,
the suspension support structure comprising:
a damper housing, which is a casting part with an open cross section opening outward in a vehicle width direction, having an upper wall with a damper connecting portion and a cover wall extending downward from a circumferential edge of the upper wall; and
a reinforcement member configured to cover at least a part of an outer opening portion of the open cross section of the damper housing in the vehicle width direction.

2. The vehicle front structure according to claim 1, wherein the reinforcement member has an inclined wall that slopes outward in the vehicle width direction from the front of the vehicle toward the rear of the vehicle beyond the damper connecting portion.

3. The vehicle front structure according to claim 2, wherein the reinforcement member has:
an upper wall portion extending along the upper wall of the damper housing and joined to the upper wall; and
the inclined wall extending to be bent or curved downward from an end portion of the upper wall portion.

4. The vehicle front structure according to claim 2, wherein the inclined wall is disposed to overlap a connecting portion of a load-receiving member connected to a front portion of the damper housing and a bumper beam of a vehicle front portion in a vehicle forward/rearward direction when seen in a plan view.

5. The vehicle front structure according to claim 2, wherein the damper housing and the reinforcement member are provided separately at left and right positions in the vehicle width direction,
the left and right damper housings are connected by a connecting beam substantially extending in the vehicle width direction, and
the left and right reinforcement members are disposed such that the inclined wall overlaps an extension region of the connecting beam in a vehicle forward/rearward direction and at least a part thereof in the vehicle forward/rearward direction.

6. The vehicle front structure according to claim 5, wherein the connecting beam has:
an upper connecting beam configured to connect the damper connecting portions of the left and right damper housings; and
a lower connecting beam located below the reinforcement member and configured to connect the left and right damper housings.

7. The vehicle front structure according to claim 2, wherein the upper wall of the damper housing has an upper wall inclined portion inclined outward from the damper connecting portion in the vehicle width direction from the front toward the rear of the vehicle, and
the inclined wall of the reinforcement member is disposed to protrude outward and forward from the upper wall inclined portion in the vehicle width direction when seen in a plan view.

8. The vehicle front structure according to claim 3, wherein the reinforcement member further has:
a front wall portion extending downward from the upper wall portion at a position in front of the vehicle and connected to a front end portion of the inclined wall; and
a sidewall portion extending downward from the upper wall portion at an outer position in the vehicle width direction and connected to a rear end portion of the inclined wall, and
the front wall portion and the sidewall portion are joined to the edge portion of the open cross section of the damper housing, so that the opening portion is closed by the reinforcement member in a horizontal cross section including the inclined wall.

9. The vehicle front structure according to claim 1, wherein the damper housing is constituted by an aluminum alloy casting part, and
the reinforcement member is formed of a metal material with higher tensile strength than the damper housing.

10. The vehicle front structure according to claim 2, further comprising:
a lower side load-receiving portion with an open cross section formed on at least two surfaces substantially extending in a vehicle forward/rearward direction, a rear portion of which is joined to the suspension support structure by joining a bumper beam to a front portion;
an upper side load-receiving portion with an open cross section formed on at least two surfaces substantially extending in the vehicle forward/rearward direction above the lower side load-receiving portion, a rear portion of which is joined to the suspension support structure; and
a connecting wall portion configured to continuously connect the lower side load-receiving portion and the upper side load-receiving portion in a vehicle forward/rearward direction,
wherein a load transmission wall extending in a direction crossing the vehicle forward/rearward direction and joined to the suspension support structure is provided on a rear portion of the upper side load-receiving portion,
the reinforcement member has:
an upper wall portion extending along the upper wall of the damper housing and joined to the upper wall;
the inclined wall extending downward from an end portion of the upper wall portion;
a front wall portion extending downward from the upper wall portion at a position in front of the vehicle and connected to a front end portion of the inclined wall; and
a sidewall portion extending downward from the upper wall portion at an outer position in the vehicle width direction and connected to a rear end portion of the inclined wall, and
the load transmission wall is joined to the damper housing and the front wall portion of the reinforcement member.
